(19) United States
(12) Patent Application Publication
(10) Pub. No.: US 2008/0068110 A1
(43) Pub. Date: Mar. 20, 2008

(54) Symmetrized coupler converting circular waveguide TM01 mode to rectangular waveguide TE10 mode

(75) Inventors: Alexei V. Smirnov, Rancho Palos Vrds, CA (US); David U.L. Yu, Rancho Palos Vrds, CA (US)

Correspondence Address: Dr. David U.L. Yu;DULY Research Inc., 1921 MacArthur Street, Rancho Palos Verdes, CA, 90275-1111, US

(73) Assignee: DULY Research Inc.

(21) Appl. No.: 11/522,149

(22) Filed: Sep. 14, 2006

(51) Int. Cl. H01P 1/163

(52) U.S. Cl. 333/21 R

(57) ABSTRACT

A coupler for converting rf power traveling in the TM01 mode in a circular waveguide to the TE10 mode in a rectangular waveguide. The circular waveguide has an extension comprising an evanescent tube through the coupler allowing the propagation of a particle beam but disallowing the propagation of rf wave in the tube.

### GOVERNMENT RIGHTS

This invention was made with government support under Grant No. DE-FG03-01ER83232 awarded by the Energy Department. The government may have certain rights in the invention.

### BACKGROUND OF THE INVENTION

1.Field of the Invention

The present invention provides a coupler for converting a radiofrequency (rf) TM₀₁ mode wave traveling in a circular waveguide to a TE₁₀ mode in a rectangular waveguide, and converting a TE01 mode in a rectangular waveguide to a TM01 mode in a circular waveguide.

2. Description of Prior Art

For many applications, a device to transmit radiofrequency (rf) power efficiently between a waveguide operating in a circular TM₀₁ mode and a perpendicular waveguide (or waveguides) operating in a rectangular TE₁₀ mode is needed. Ideally, such a passive device should not have reflections in a broad band of operation. In addition, in many cases it must have an additional (outlet) port allowing no rf power flow, placed along the same axis as that of the circular port for purposes such as electron beam transport, diagnostics, monitoring, manipulation, and so on.

The TM₀₁ mode is a common operating mode for a cylindrical waveguide used in a number of electronic vacuum devices and facilities. The TE₁₀ mode is a standard operating mode for a rectangular waveguide for transporting rf power. There are many different designs for single-port and two-port couplers for transforming a TM₀₁ mode in a circular waveguide to a TE₁₀ mode in one or two rectangular waveguides. For example, single-port input and output couplers have been used in traveling-wave devices such as linacs, traveling wave tubes (TWTs), backward wave oscillators (BWOs) and twystrons for over fifty years. In these devices, the coupler is integrated or connected to the slow wave cylindrical structure performing at TM₀₁ mode. More recently, in high power pulsed klystrons, power extractors, and linacs, 2-rectangular-port couplers are used to transmit higher power with reduced internal overvoltage connected to the rf source through the coupler and rectangular waveguides. The maximum attainable bandwidth depends on the relationship between three values: the operating wavelength, circular port dimensions, and transformation into parasitic modes. Downsizing (or removal) of the idle port makes it easier for the design to attain wider bandwidth.

Typical coupler designs always have some transformation of the fundamental operational mode into unwanted modes which may narrow bandwidth and, if an electron beam is present, can also drive dangerous instabilities (such as notable “beam break-up”) that can eventually destroy the entire device. To reduce this transformation in a single-rectangular-port coupler, two additional stubs on opposite sides have been used in many designs. The symmetrized couplers lessen but do not eliminate the problem of unwanted modes. In addition, the stubs may introduce additional eigenmodes if the coupler is used as a high-Q cavity. Such a mode trapped in the coupler can degrade the performance of the whole device assembly.

### SUMMARY OF THE INVENTION

The present invention provides a device for converting rf power in a TM₀₁ mode in a circular waveguide to a TE₁₀ mode in a rectangular waveguide. The rf waves move through the circular waveguide to the rectangular waveguide by way of electromagnetic wave interference of forward and reflected waves from the walls so as to cancel net reflection back out of the coupler. Alternatively, the device may also achieve the reverse result by converting rf power in the TE₁₀ mode in the rectangular waveguide to the TM₀₁ mode in the circular waveguide.

The device of the present invention provides a symmetrized coupler designed to have significantly reduced transformation into dipole and quadrupole modes with the absence of trapped monopole modes. The device can have one, two or four standard rectangular ports. The coupler of the present invention provides better bandwidth than prior art couplers, while also providing a nearly perfect transmission coefficient within the bandwidth.

The coupler of the present invention is constructed from metal, copper being the preferred material. Brazing and electroforming are preferred methods of fabrication of the coupler. Chemical etching of the coupler components may be used to further tune the frequency of the coupler after initial fabrication.

Two embodiments of the coupler in the present invention are described herein. The first embodiment comprises a rectangular waveguide orthogonal to a circular waveguide and an evanescent pipe opposite thereto having a reduced diameter. Two rectangular stubs opposite to the rectangular waveguide, and a short member of the evanescent pipe protruding into the main chamber of the coupler, are used to symmetrize the coupler. The second embodiment comprises one or more rectangular waveguides orthorgonal to a circular waveguide and an evanescent pipe opposite thereto. A plurality of rods parallel to the axis of the circular waveguide are used to symmetrize the coupler. With given relationships between operating wavelength, critical wavelength of the rectangular waveguide, and diameters of the circular waveguide and the outlet extension thereof, the bandwidth around the design frequency is about 6% when the S₂₁ transmission coefficient is higher than 90%. The bandwidth can be readily increased varying these relationships. For example, using a bigger diameter of the circular waveguide and a small diameter for the outlet extension, the bandwidth can exceed 12-15%. In spite of the closeness between the cutoffs of both the circular waveguide and the outlet extension thereof, the designs demonstrate a very good overall performance that is not achievable with conventional designs.

Furthermore, computer simulations show that for the second embodiment of the device of the present invention to be described below, the transformation from the operating TM₀₁ mode into parasitic dipole and quadrupole modes is about one order less than that in conventional design using a single stub to symmetrize the coupler, the coupler not having any trapped monopole modes. The overvoltage (defined as the ratio of the maximum surface electric field inside the coupler to that in the rectangular waveguide) is also very moderate (˜2.12), which allows for the use of the coupler in high power applications. Finally, additional one to three rectangular ports can be attached to the coupler without changing the geometry of the coupler in other respects.

One application of this device is to feed rf power from a rectangular waveguide to a linear electron accelerator. It may also be used to extract rf power from an electronic vacuum or plasma device generating rf power, such as when an electron beam goes through a slow-wave system. This device can alternatively serve as a mode converter for antenna and radar technology or for telecommunications. More generally, the device of the present invention is useful in applications that require a high quality of nearly single-mode operation in rf power transmission.

### DESCRIPTION OF THE DRAWINGS

For a better understanding of the present invention and further features thereof, reference is made to the following descriptions which are to be read in conjunction with the accompanying drawings wherein.

FIG. 1 is a perspective view of the first embodiment of the coupler of the present invention;

FIG. 2a is a sectional view of the coupler along line A-A of FIG. 1;

FIG. 2b is a sectional view of the coupler along line B-B of FIG. 1;

FIG. 3 illustrates the S-parameters calculated for the coupler shown in FIG. 1;

FIG. 4 is a perspective view of the second embodiment of the coupler of the present invention;

FIG. 5a is a sectional view of the coupler along line C-C of FIG. 4;

FIG. 5b is a sectional view of the coupler along line D-D of FIG. 4; and

FIG. 6 illustrates the S-parameters calculated for the coupler shown in FIG. 4.

### DESCRIPTION OF THE INVENTION

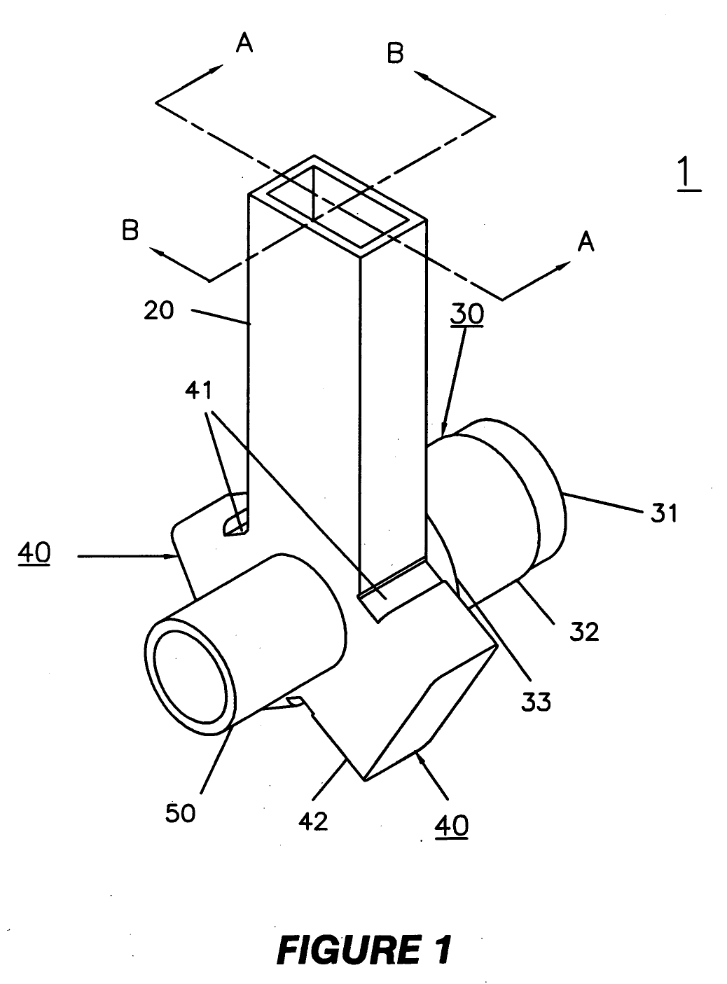

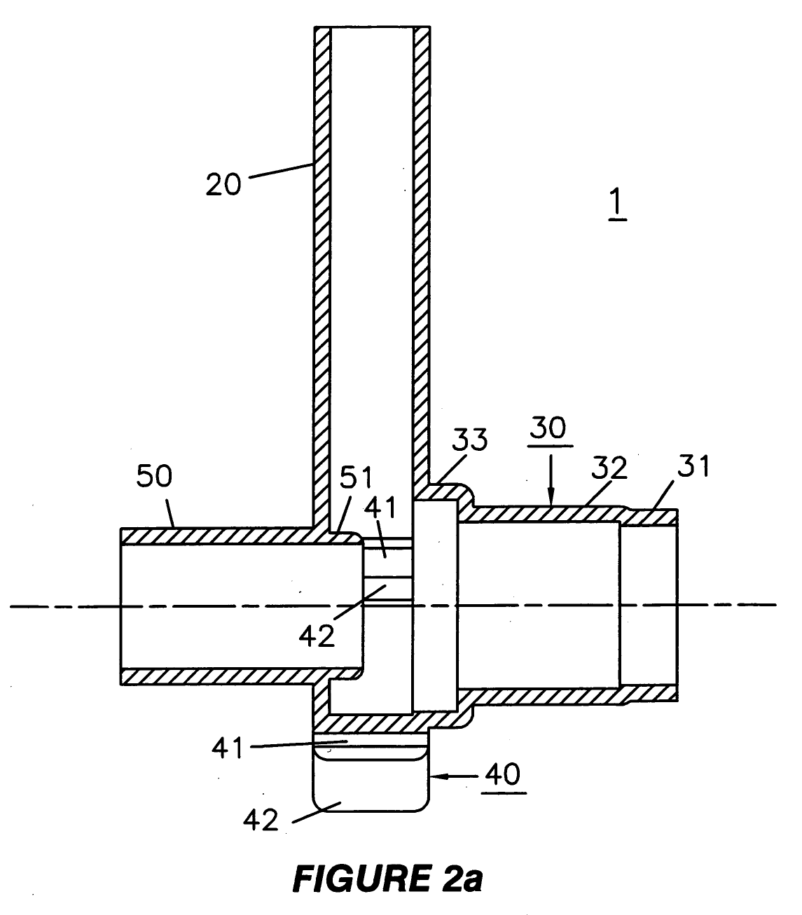

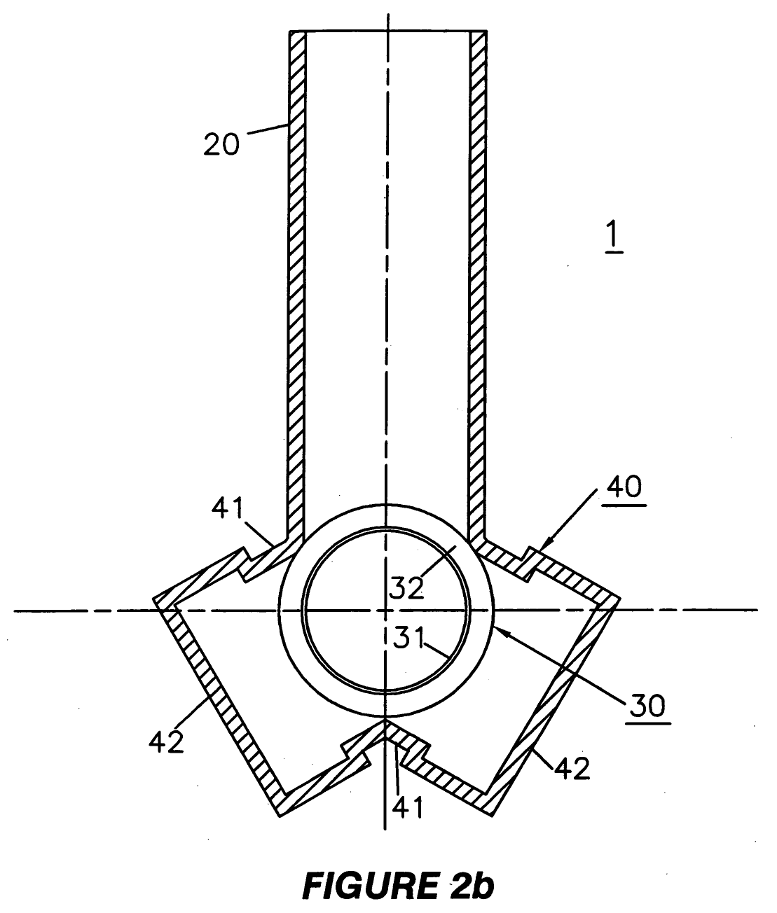

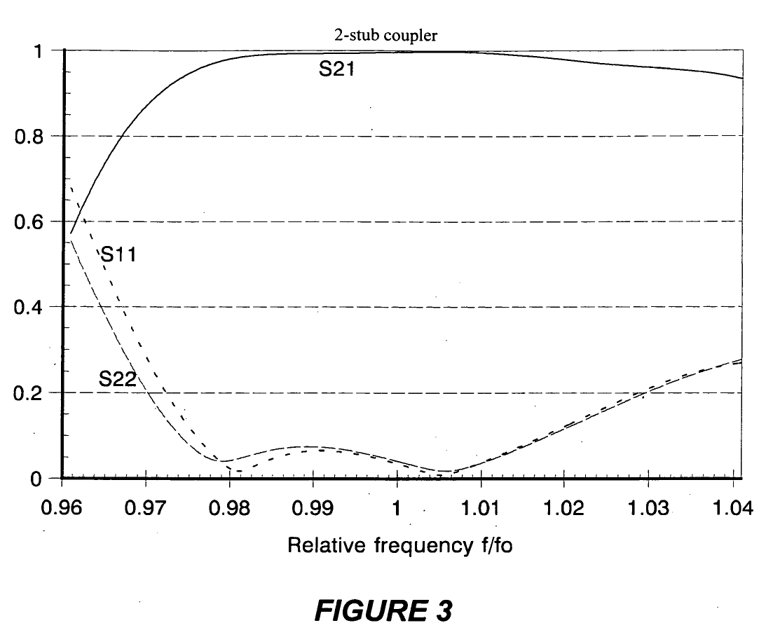

Referring to FIGS. 1, 2a and 2b, the first embodiment of the coupler 1 of the present invention is illustrated. FIG. 2a is a view at a mid section of the coupler 1 parallel to the axis of the circular waveguide 30. FIG. 2b is a view at a mid section perpendicular to the axis of the circular waveguide 30. The single arm coupler 1 comprises a rectangular waveguide 20, a circular waveguide 30, two rectangular stubs 40, an evanescent pipe 50, and an extension ring 51 of the evanescent pipe 50, which protrudes into the circular waveguide 30. In the design illustrated in FIGS. 1 and 2, the circular port 31 of waveguide 30 has a diameter exceeding the cutoff dimension of the TM₀₁ mode by only a few percent. This requires three sections in the circular waveguide 30: the port end 31 of waveguide 30 having the smallest diameter, the mid-section 32 having a larger diameter, and the third section 33, containing the junction area of the coupler components, having the largest diameter. The rectangular waveguide 20 is connected perpendicularly at this junction to the third section 33 of the circular waveguide. The two stubs 40 are connected perpendicularly to the circular waveguide 30 at the junction section 33, extending 120 degrees on each side of the rectangular waveguide 20. Each stub 40 has a rectangular neck, or compartment, 41 and a closed rectangular cap, or cover, 42. The stub neck 41 is connected to the junction section 33 of the circular waveguide 30 at one end and the closed stub cap 42 at the other. The height of the stub 40 (the dimension parallel to the axis of the circular waveguide) is the same as that of the rectangular waveguide. The width of the stub cap 42 (the other dimension perpendicular to the center line of the stub) is wider than that of the connected stub neck 41. The extension ring 51 of the evanescent pipe 50 extends into the circular waveguide 33. The open end of the extension ring 51 is rounded so as to reduce the peak electric field, or the overvoltage, on its surface. The diameter of the evanescent pipe 50 must be smaller than the TM₀₁ cutoff diameter at the given operating frequency in order to provide high transmission without rf propagation into that pipe. In applications in which an electron beam is present in the circular waveguide 30, the evanescent pipe 50 permits outflow of the e-beam from the coupler. For an understanding of the performance of the coupler 1 in the present invention, FIG. 3 shows the reflection and transmission coefficients characterized by the S-parameters. The S-parameters are computed using a known commercial computer simulation code (CST Microwave Studio, developed by CST of America, Inc., North Cambridge, Mass.). Referring to FIG. 3, S21 is the transmission coefficient of the rf wave from the circular waveguide 30 in the TM₀₁ mode to the rectangular waveguide 20 in the TE₁₀ mode, and vice versa. Nearly 100% of the rf wave is transmitted at the design frequency. For an illustrative geometry chosen for this simulation, the bandwidth is about 6% around the design frequency for S21 transmission coefficients higher than 90%. Referring again to FIG. 3, S11 is the reflection coefficient of the rf wave in the TM₀₁ mode at the entrance of the circular waveguide 30, and S22 is the reflection coefficient of the rf wave in the TE₁₀ mode at the entrance of the rectangular waveguide 20. Both S11 and S22 are very small at the design frequency, indicating practically no reflections. The specific geometry of coupler 1 and its dimensions shown in FIGS. 1 and 2 are for illustration only. These dimensions may be changed without departing from the teachings of the invention.

Unlike single-stub conventional geometry, the two stubs provide better symmetrization of the coupler to broaden the bandwidth, maximize the transmission, and decrease unwanted transformation into parasitic modes in the vicinity of the operating frequency.

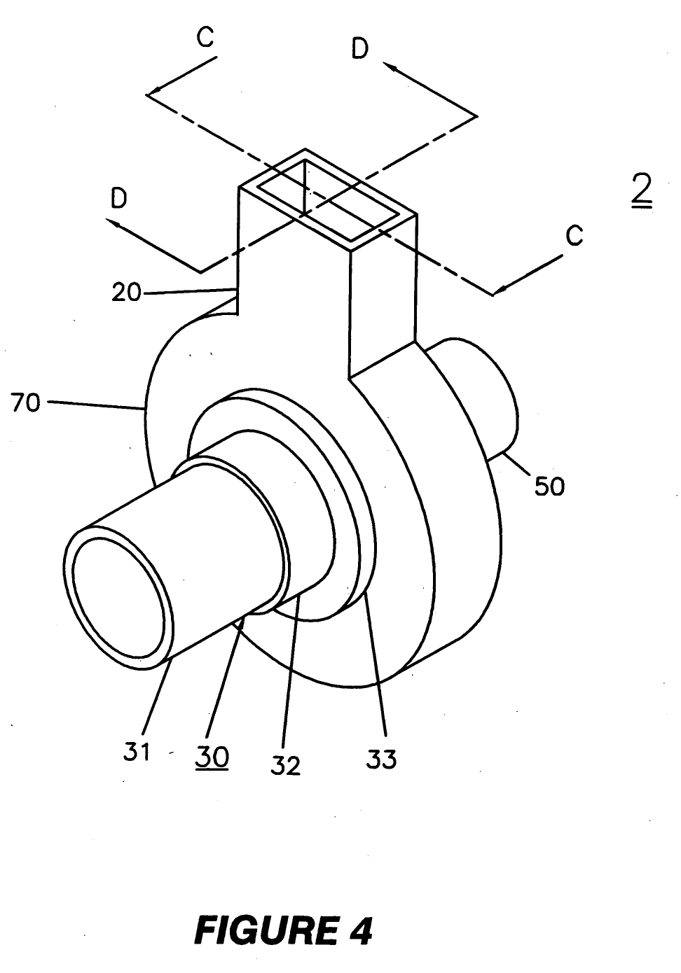

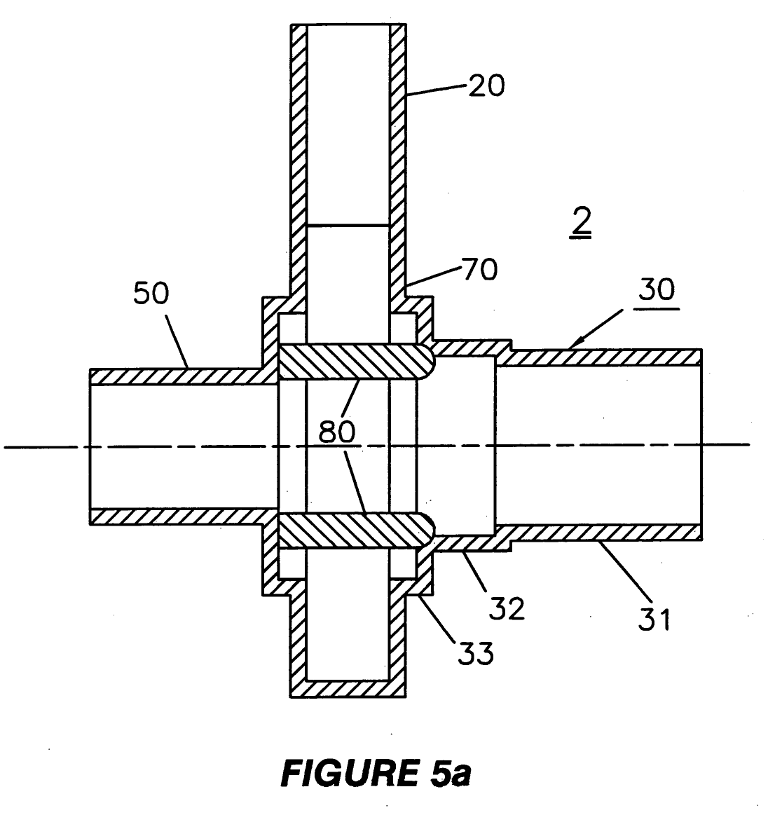

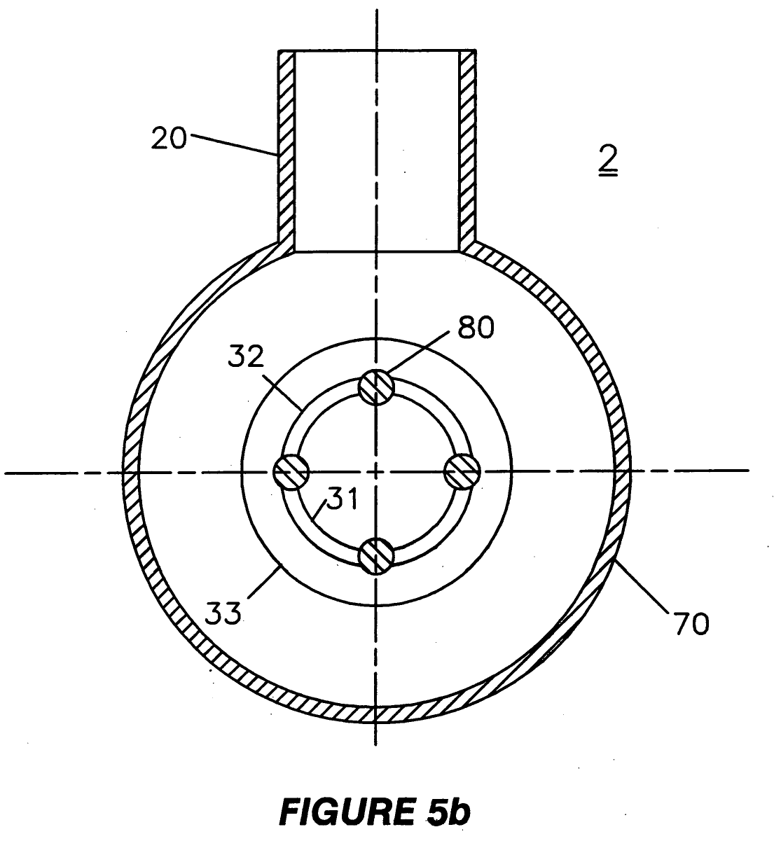

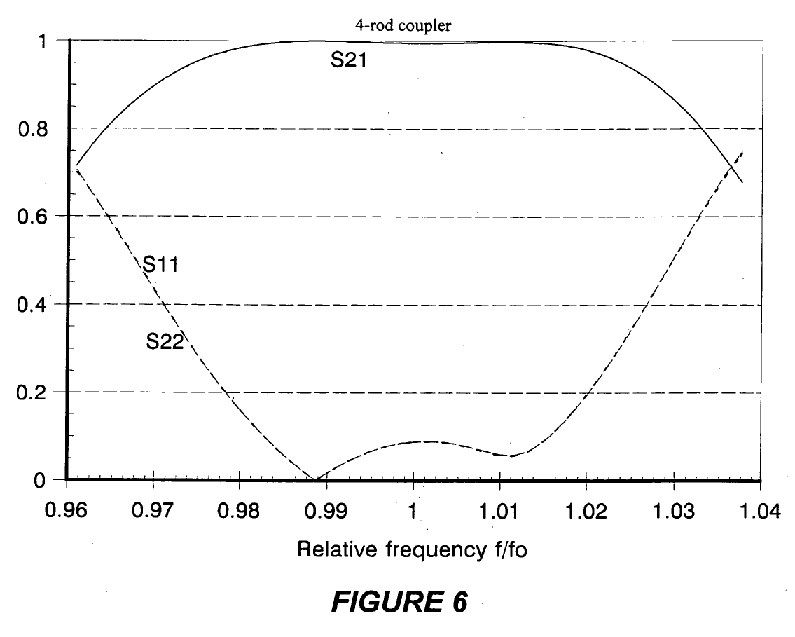

FIGS. 4, 5a and 5b illustrate a second embodiment of the coupler 2 of the present invention using a rod-loaded pillbox design. FIG. 5a is a view at a mid section of the coupler 2 parallel to the axis of the circular waveguide 30. FIG. 5b is a view at a mid section perpendicular to the axis of the circular waveguide 30. Coupler 2 comprises a rectangular waveguide 20, a circular waveguide 30, an evanescent pipe 50, and a symmetrized pillbox cavity 70 wherein a plurality of rods 80 is placed parallel to its axis. In the preferred embodiment, there are four rods 80. The design of rods 80 is set forth in co-pending application Ser. No. ______, filed ______, the teachings of which are incorporated herein by reference. The rod-loaded pillbox cavity 70 acts effectively as a symmetric modal filter, whereas the surrounding cylindrical volume serves as a built-in combiner of four-to-one type. This design also allows for 2 or 4 rectangular ports. The 4-rod design is sensitive mostly to the rod position and dimensions and is much less sensitive to other internal coupler dimensions. As in the first embodiment of the coupler 1, coupler 2 has a staggered three-section circular waveguide 30, wherein the port-end section 31 that extends outward from the coupler has the smallest diameter, the midsection 32 has a larger diameter, and the third section 33, containing the junction of the coupler, has the largest diameter. In the embodiment of the coupler 2, the third section 33 of the circular waveguide 30 intersects with a junction pillbox cavity 70 which has a larger diameter. The rectangular waveguide 20 is connected to the junction pillbox cavity 70, perpendicular to the circular waveguide 30. The evanescent pipe 50 is connected along the same axis of the circular waveguide 30 to the end of the third section 33 of the circular waveguide 30 that extends past the pillbox cavity 70. The diameter of pipe 50 is smaller than the TM₀₁ cutoff diameter so as to prevent rf power from propagating therein. In applications in which an electron beam is present in the circular waveguide 30, this allows the electron beam to propagate through the device. The four rods 80 are located equidistant from each other within the coupler and oriented parallel to the axis of the circular waveguide. The rods 80 are attached at one end to the wall where the evanescent pipe 50 joins the junction cavity 70. The rods 80 extend from these points of attachment toward the circular waveguide 30, and are attached to the wall of the third, largest section 33 of the circular waveguide 30 joining the junction cavity 70. At these attachment locations, holes are drilled into the waveguide walls so that the rods 80 may partially protrude from the circular waveguide 30. The end of the protruding member of the rod 80 is rounded in order to minimize overvoltage at its surface. FIG. 6 illustrates the performance of coupler 2 as characterized by the reflection and transmission coefficients, or S-parameters (calculated with the computer code CST Microwave Studio). Referring to FIG. 6, S21 is the transmission coefficient of the rf wave from the circular waveguide 30 in the TM₀₁ mode to the rectangular waveguide 20 in the TE₁₀ mode; and vice versa. Nearly 100% of the rf wave is transmitted at the design frequency. Referring again to FIG. 6, S11 is the reflection coefficient of the rf wave in the TM₀₁ mode at the entrance of the circular waveguide 30, and S22 is the reflection coefficient of rf wave in the TE₁₀ mode at the entrance of the rectangular waveguide 20. Both S11 and S22 are very small at the design frequency, indicating practically no reflections. While the invention has been described with reference to its preferred embodiments, it will be understood by those skilled in the art that various changes may be made and equivalents may be substituted for elements thereof without departing from the true spirit and scope of the invention. In addition, many modifications may be made to adapt a particular situation or material to the teachings of the invention without departing from its essential teachings.

What is claimed is:

1. A coupler which converts radiofrequency power in a TM₀₁ mode in a circular waveguide to a TE₁₀ mode in a rectangular waveguide comprising a plurality of inlet concentric circular pipes of varying diameters formed about an axis, a rectangular waveguide and two symmetric stubs coupled to one of said circular pipes, and an additional outlet circular pipe opposite to said inlet circular pipes; said coupler minimizing power reflection back to the circular waveguide and the rectangular waveguide for their respective operating modes, and maximizing power transmission for the operating modes between the circular waveguide and the rectangular waveguide; said coupler further minimizing power transmission for the operating modes between said inlet circular waveguide and said outlet circular pipe, and between said rectangular waveguide and said outlet circular pipe.

2. The coupler of claim 1 wherein said circular and concentric inlet pipes have variable diameters, one of said concentric pipes functioning as a junction cylinder having a sidewall to which said rectangular waveguide is attached;
said junction cylinder being concentric with the last of said concentric circular waveguide; and said rectangular waveguide being substantially perpendicular to said circular waveguides.

3. The coupler of claim 2 wherein symmetric rectangular stubs are attached to said junction cylinder on the opposite sidewall thereof from said rectangular waveguide, each of said stubs having a rectangular compartment of smaller dimension and a rectangular cover of larger dimension.

4. The coupler of claim 2 in which said outlet circular pipe is attached to said junction cylinder on the opposite side of said circular waveguide and concentric about said axis, said outlet pipe having a small diameter to cut off propagation therein of radiofrequency wave in the operating mode.

5. The coupler of claim 2 in which said outlet circular pipe extends into said junction cylinder; the end of said extended pipe inside said junction cylinder being rounded to reduce overvoltage on the surface of said extended pipe.

6. A coupler which converts radiofrequency power in a TM₀₁ mode in a circular waveguide to a TE₁₀ mode in a rectangular waveguide, comprising a plurality of inlet circular and concentric waveguides of variable diameters, one of which being connected to a concentric junction pillbox cavity and having a side wall, and having a diameter greater than any of said variable diameters, a rectangular waveguide being attached to said junction pillbox; said rectangular waveguide being substantially perpendicular to said circular waveguides; an outlet circular pipe attached to said junction pillbox cavity opposite to the circular waveguides; and a plurality of rods, positioned within said junction pillbox cavity; said coupler minimizing power reflection back to the circular waveguide and the rectangular waveguide for their respective operating modes, and maximizing power transmission for the operating modes between the circular waveguide and the rectangular waveguide; said coupler further minimizing power transmission for the operating modes between said inlet circular waveguide and said outlet circular pipe, and between said rectangular waveguide and said outlet circular pipe.

7. The coupler of claim 6 in which said plurality of rods are positioned inside said junction pillbox cavity and parallel to the axis of said junction pillbox cavity; said rods being equidistant from the nearest rods and from the center of the cavity.

8. The coupler of claim 6 in which the one end of each rod is attached to the end wall of the circular waveguide adjacent said junction pillbox cavity, the other end of said rod being partially attached to said waveguide wall, said rods having rounded ends protruding from said junction pillbox cavity to prevent overvoltage at the rod surfaces.

9. The coupler of claim 6 in which said rods are attached to the end wall of said junction pillbox cavity at the opposite end of said circular waveguide.

10. The coupler of claim 6 in which said outlet circular pipe is concentric with said inlet circular waveguides.

11. The coupler of claim 6 in which a plurality of rectangular waveguides being substantially perpendicular to said circular waveguides are attached to the sidewall of said junction pillbox cavity being loaded with rods.
